(19) United States
(12) Patent Application Publication
(10) Pub. No.: US 2007/0101301 A1
(43) Pub. Date: May 3, 2007

(54) SIMULATION APPARTUS, SIMULATION METHOD, AND SEMICONDUCTOR DEVICE

(75) Inventor: Masayasu MIYATA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/470,027

(22) Filed: Sep. 5, 2006

(30) Foreign Application Priority Data
Sep. 7, 2005 (JP) 2005-258849
Aug. 18, 2006 (JP) 2006-223022

(51) Int. Cl. G06F 17/50

(52) U.S. Cl. 716/1

(57) ABSTRACT

An apparatus for simulating a current-voltage characteristic of a device includes an atomic structure creating unit that creates an atomic structure model of the device, an electronic structure calculating unit that calculates an electronic structure in the atomic structure model, a first IV characteristic calculating unit that calculates the current-voltage characteristic of the device by considering a quantum effect and the atomic structure on the basis of the electronic structure calculated by the electronic structure calculating unit, a second IV characteristic calculating unit that calculates the current-voltage characteristic on the basis of the electronic structure using a semiclassical approximation method, and a combining unit that combines a first current-voltage characteristic obtained by the first IV characteristic calculating unit and a second current-voltage characteristic obtained by the second IV characteristic calculating unit such that the first current-voltage characteristic is applied to a low voltage side on the basis of a position of approaching the both first and second current-voltage characteristics and the second current-voltage characteristic is applied to a high voltage side on the basis of approaching the both first and second current-voltage characteristics to obtain the current-voltage characteristic of the device.

### BACKGROUND

1. Technical Field

The present invention relates to a simulation apparatus, to a simulation method, and to a semiconductor device.

2. Related Art

An electronic device size is presently scaling down to have high performance to the nano-size regime. Miniaturization of the electronic device results in a decrease in reliability and performance variation, which causes reduction in product yield and increase in the number of development processes for verification. Therefore, at the scene of process and device development, a computer simulation tool, for example, an electronic device automation (EDA) tool that is capable of predicting performance with high accuracy has been used, and its importance has been increased every year. In general, the EDA tool is expensive, has a lack of universality in systems to be handled, and requires a large-scale calculation.

The basic characteristic of a device is a current-voltage (IV) characteristic. Therefore, for a design of a high-performance device, prediction of IV characteristics with high accuracy is important. In the related art, prediction is possible by a method that applies a semiclassical theory to a simplified band structure model and fits a parameter to a measurement value (see M. Fukuda et al., “Analysis of Tunnel Current through Ultrathin Gate Oxides”, Jpn. J. Appl. Phys., 37, L1534 (1998) (non-patent document 1)).

However, when the device size scales down to the nano-size regime, since influence of a structure at an atomic level and a quantization effect is increased, prediction accuracy is reduced in the method according to the related art. When the prediction accuracy is low, a plurality of measurement values are required for verification to thereby increase development costs. For example, in an insulating film having a thickness of 1 to 3 nm, a leakage current is large because of a quantum tunneling effect. However, IV characteristics of a low applied voltage of 0 to 1 V cannot be achieved in the simplified band model.

As regards the influence of the quantum effect, various corrections are made with the quantum effect included in the method according to the related art, which is integrally formed in the EDA tool. There is predicting capability that can be practically used, while universality is low because a structural change at the atomic level is not adopted. As a result, a plurality of measurement values are required.

Meanwhile, a first principal calculation method that accurately receives the influence of the quantum effect and the atomic structure has been developed. However, since a calculation amount becomes huge in order to obtain realistic accuracy, it may be impossible to make a calculation in most cases unless the structure is drastically approximated. In addition, since there may be various instruments involved in electrical conduction, if the instruments are taken into account from the beginning, the calculation method becomes complicated and it is unpractical because of difficult development problems. As a method that accuracy is not affected and the calculation amount is small, there is a method that combines a non-equilibrium Green's function (NEGF) method with a Density Functional Theory (DFT) (see X. Zhang et al., The Application of Density Functional, Local Orbitals, and Scattering Theory to Quantum Transport“, phys. stat. sol. (b)233, No. 1, 70-82(2002) (non-patent document 2)).

However, in order to apply the above-described method to an actual device, a large calculation amount is still needed. In addition, even though an attempt of calculation of a system of a small number of atoms has been made for actual electrical conduction, prediction accuracy that can be practically used, that is, quantitative agreement with an experiment value has not been obtained yet. Therefore, no one has succeeded in constantly predicting the IV characteristic on the basis of the first principle theory. In addition, the first principle calculation is unrealistic because a calculation scale that is needed to handle a thick film (e.g., 3 nm or more) or perform a calculation of a high voltage (for example, 1 V or more) is excessively large.

### SUMMARY

An advantage of some aspects of the invention is to provide a simulation apparatus, a simulation method, a simulation program, a recording medium, and a semiconductor device that are capable of predicting IV characteristics with high accuracy with respect to voltage and film thickness in a wide range without increasing a calculation scale.

A simulation apparatus according to a first aspect of the invention includes an atomic structure creating unit that creates an atomic structure model of the device, an electronic structure calculating unit that calculates an electronic structure in the atomic structure model, a first IV characteristic calculating unit that calculates the current-voltage characteristic of the device by considering a quantum effect and the atomic structure on the basis of the electronic structure calculated by the electronic structure calculating unit, a second IV characteristic calculating unit that calculates the current-voltage characteristic on the basis of the electronic structure using a semiclassical approximation method, and a combining unit that combines a first current-voltage characteristic obtained by the first IV characteristic calculating unit and a second current-voltage characteristic obtained by the second IV characteristic calculating unit such that the first current-voltage characteristic is applied to a low voltage side on the basis of a position of approaching the both first and second current-voltage characteristics and the second current-voltage characteristic is applied to a high voltage side on the basis of approaching the both first and second current-voltage characteristics to obtain the current-voltage characteristic of the device.

According to this configuration, the first IV (current-voltage) characteristic obtained using a quantum theoretic method is applied to a region that has a small electric field intensity (E) that is largely affected by the quantum effect and the atomic structure and a second IV characteristic obtained using the semiclassical approximation method is applied to a region that has a large electric field intensity (E) that is minimally affected by the quantum effect and the atomic structure to obtain the current-voltage characteristic of the device. Therefore, it is possible to calculate an IV characteristic that preferably matches with a measurement value in the larger electric field, and a system size, at low calculation costs.

Preferably, a correcting unit that corrects the first current-voltage characteristic obtained by the first IV characteristic calculating unit using a voltage correction value is further included. Here, the combining unit combines the first current-voltage characteristic corrected by the correcting unit and the second current-voltage characteristic.

According to this configuration, the simulation apparatus includes the correcting unit, and the calculation of the IV characteristic by the quantum theoretic method is performed when the electric field is zero. Further, the internal electric field is corrected on the basis of the obtained IV characteristic (first IV characteristic), thereby matching the IV characteristic with a measurement value. Therefore, it is possible to obtain a calculation result that preferably matches the IV characteristic with the measurement method in a nano-size region with the same calculation amount as the related art.

Preferably, in the atomic structure creating unit, an atomic structure model of the device including a first material, a second material, and a third material having an interface of the first and second materials is created as an atomic structure model having the steep interface having no irregularities or coordination defects.

According to the above configuration, it is possible to construct an atomic structure model that is capable of preferably matching a theoretical prediction value with the measurement value and to provide a simulation apparatus that is capable of obtaining an accurate theoretical prediction value. By adopting the interface structure, the high conformity to a process that is capable of forming a high quality film is secured, and it is applicable to a device simulation apparatus for controlling a process in a nano-size region.

Preferably, in the atomic structure creating unit, an atomic structure model of the device including a SiO₂ film and a Si film which have an interface therebetween is created as an atomic structure model having the steep interface having no irregularities or coordination defects between the SiO₂ film and the Si film.

By using the above-mentioned structure as the structure of the Si/SiO₂ interface, it is possible to provide a simulation apparatus that more accurately simulates a device having an oxide film with extremely high quality.

Preferably, the interface of the SiO₂ film and the Si film is set at a central position of a Si—C binding that is positioned at a SiO₂ film side of the SiOₓ tetrahedron where an oxidation valence of Si of the SiO₂ film is 3.

According to the above configuration, it is possible to easily obtain a simulation result that preferably matches with the measurement value.

A simulation method according to a second aspect of the invention includes creating an atomic structure model of a device, calculating an electronic structure in the atomic structure model, calculating a first current-voltage characteristic of the device by considering a quantum effect and the atomic structure on the basis of the calculated electronic structure, calculating a second current-voltage characteristic using a semiclassical approximation method on the basis of the electronic structure, and combining the first current-voltage characteristic and the second current-voltage characteristic such that the first current-voltage characteristic is applied to a low voltage side on the basis of a position of approaching the both first and second current-voltage characteristics and the second current-voltage characteristic is applied to a high voltage side on the basis of the position of approaching the both first and second current-voltage characteristics to obtain the current-voltage characteristic of the device.

According to this configuration, the first IV (current-voltage) characteristic obtained using a quantum theoretic method is applied to a region that has a small electric field intensity (E) that is largely affected by the quantum effect and the atomic structure and the second IV characteristic obtained using the semiclassical approximation method is applied to a region that has a large electric field intensity (E) that is minimally affected by the quantum effect and the atomic structure to obtain the current-voltage characteristic of the device. Therefore, it is possible to calculate an IV characteristic that preferably matches with a measurement value in the wider electric field, and a system size, at low calculation costs.

Preferably, the simulation method further includes correcting the first current-voltage characteristic obtained in the calculation of the first current-voltage characteristic using a voltage correction value. Here, in the combining of the first currents voltage characteristic and the second current-voltage characteristic, the corrected first current-voltage characteristic and the second current-voltage characteristic are combined.

According to this configuration, the calculation of the IV characteristic by the quantum theoretic method is performed when the electric field is zero. Further, the internal electric field is corrected on the basis of the obtained IV characteristic (first IV characteristic), thereby matching the IV characteristic with a measurement value. Therefore, it is possible to obtain a calculation result that preferably matches the IV characteristic with the measurement method in a nano-size region with the same calculation amount as the related art.

Preferably, in the creating of the atomic structure model of the device, the device is set as a device including a first material, a second material, and a third material having an interface of the first and second materials, and interfaces among the first material, the second material, and the third material are set as steep interfaces having no irregularities or coordination defects.

Therefore, by adopting the interface structure, the high conformity to a process that is capable of forming a high quality film is secured, and it is applicable to a device simulation apparatus in controlling a process in a nano-size region.

Preferably, in the creating of the atomic structure model of the device, an interface between a SiO₂ film and a Si film of the device including the SiO₂ film and the Si film which have the interface therebetween is set as a steep interface having no irregularities or coordination defects.

By using the above-mentioned structure as the structure of the Si/SiO₂ interface, it is possible to provide a simulation apparatus that more accurately simulates a device including an oxide film with extremely high quality.

Preferably, the interface of the SiO₂ film and the Si film is set at a central position of a Si—O binding that is positioned at a SiO₂ film side of the SiOₓ tetrahedron where an oxidation valence of Si of the SiO₂ film is 3.

According to the above configuration, it is possible to easily obtain a simulation result that preferably matches with the measurement value.

According to a third aspect of the invention, a simulation program is provided that allows a computer performing a simulation of a device to perform a process of creating an atomic structure model of a device, a process of calculating an electronic structure in the atomic structure model, a process of calculating a first current-voltage characteristic of the device by considering a quantum effect and the atomic structure on the basis of the calculated electronic structure, a process of correcting the first current-voltage characteristic obtained in the calculation of the first current-voltage characteristic using a voltage correction value, a process of calculating a second current-voltage characteristic using a semiclassical approximation method on the basis of the electronic structure, and a process of combining the corrected first current-voltage characteristic and the second current-voltage characteristic such that the first current-voltage characteristic is applied to a low voltage side on the basis of a position of approaching the both first and second current-voltage characteristics and the second current-voltage characteristic is applied to a high voltage side on the basis of the position of approaching the both first and second current-voltage characteristics to obtain the current-voltage characteristic of the device.

According to a fourth aspect of the invention, a computer recordable recording medium records a computer program that allows a computer performing a simulation of a device to perform: a process of creating an atomic structure model of a device, a process of calculating an electronic structure in the atomic structure model, a process of calculating a first current-voltage characteristic of the device by considering a quantum effect and the atomic structure on the basis of the calculated electronic structure, a process of correcting the first current-voltage characteristic obtained in the calculation of the first current-voltage characteristic using a voltage correction value, a process of calculating a second current-voltage characteristic using a semiclassical approximation method on the basis of the electronic structure, and a process of combining the corrected first current-voltage characteristic and the second current-voltage characteristic such that the first current-voltage characteristic is applied to a low voltage side on the basis of a position of approaching the both first and second current-voltage characteristics and the second current-voltage characteristic is applied to a high voltage side on the basis of the position of approaching the both first and second current-voltage characteristics to obtain the current-voltage characteristic of the device.

In this case, the term ‘recording medium’ refers to a medium that records a program, such as an external memory of a computer, a semiconductor memory, a magnetic disk, an optical disk, a magneto-optic disk, a magnetic tape. Specifically, it includes a CD-ROM, an MO disk, a hard disk, a cassette tape, etc.

Further, a semiconductor device according to a fifth aspect of the invention may be designed on the basis of a current-voltage characteristic obtained by the simulation method.

### BRIEF DESCRIPTION OF THE DRAWINGS

The invention will be described with reference to the accompanying drawings, wherein like numbers reference like elements.

FIG. 1 is a view showing a configuration of a simulation apparatus according to an embodiment of the invention

FIG. 2 is a flow chart illustrating a simulation method according to another embodiment of the invention.

FIGS. 3A and 3B are a cross-sectional view illustrating a configuration of a device according to another embodiment of the invention.

FIGS. 4A and 4B are views illustrating a Si/SiO₂ interface structure of the device according to the embodiment of the invention.

FIG. 5 is an exemplary view illustrating a configuration of a device according to another embodiment of the invention.

FIGS. 6A and 6B are exemplary views illustrating a configuration of a device according to another embodiment of the invention.

FIG. 7 is a graph showing first IV characteristics of a device according to another embodiment of the invention.

FIG. 8 is a graph showing second IV characteristics of a device according to another embodiment of the invention.

FIG. 9 is a graph showing both of IV characteristics of FIG. 7 and FIG. 8.

FIG. 10 is a graph showing IV characteristics after combination processing.

FIG. 11 is a schematic block diagram showing a simulation device according to another embodiment of the invention.

### DESCRIPTION OF EXEMPLARY EMBODIMENTS

Simulation Apparatus

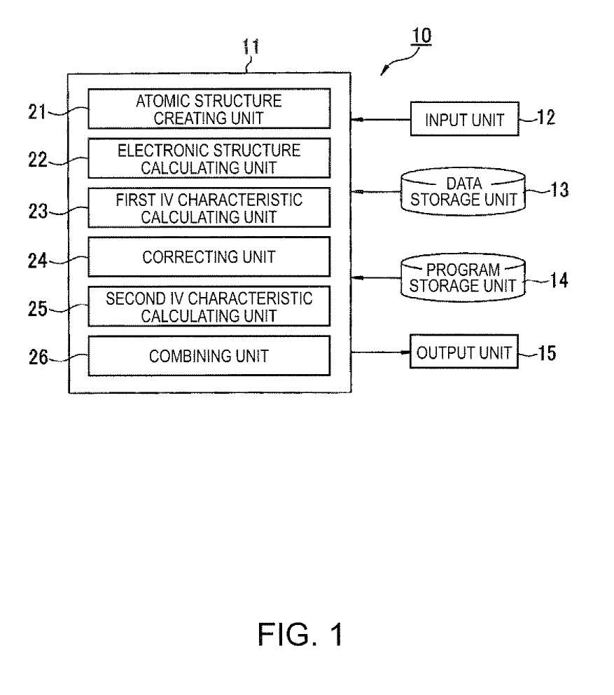

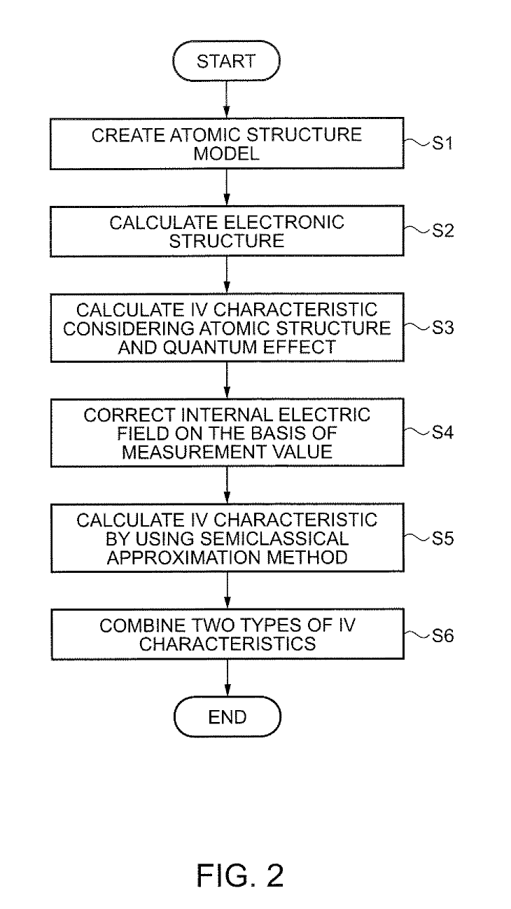

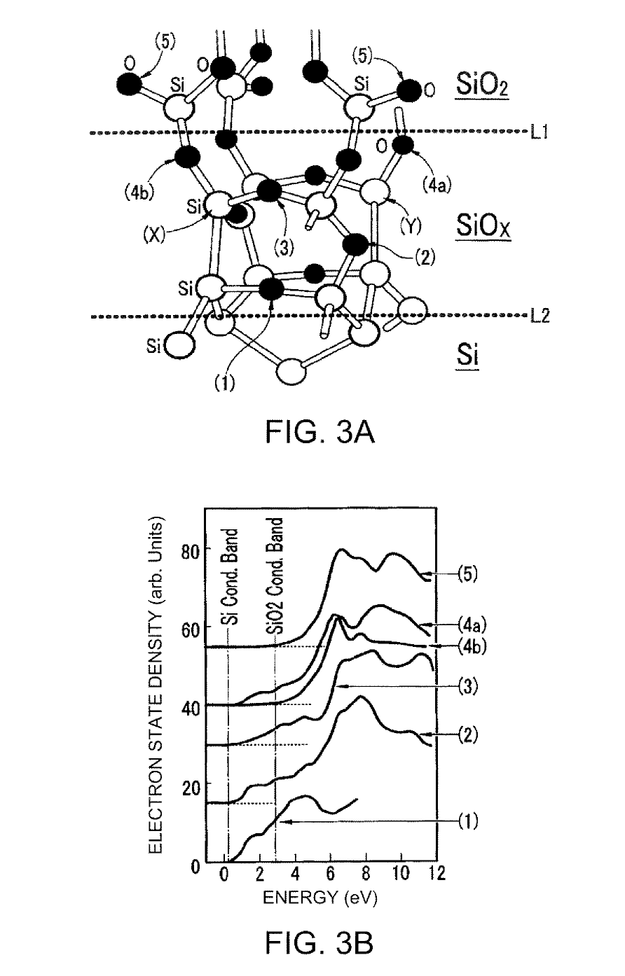

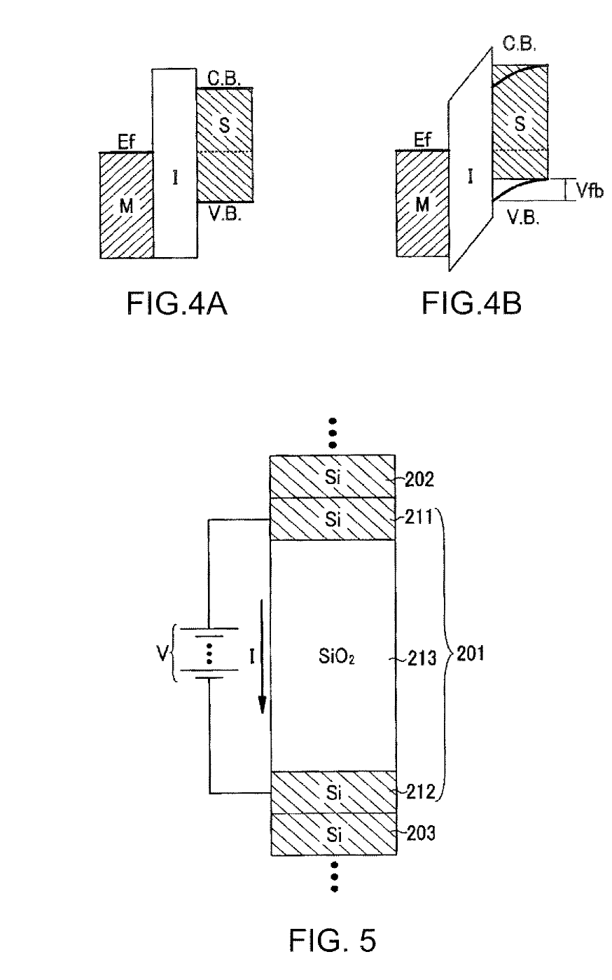

A preferred embodiment of the invention will now be described with reference to the accompanying drawings. FIG. 1 is a block diagram illustrating a functional construction of a simulation apparatus 10 according to an embodiment of the invention FIG. 2 is a flowchart illustrating a simulation method according to another embodiment of the invention. FIGS. 3A and 3B are diagrams illustrating an interface structure of Si/SiO₂. FIGS. 4A and 4B are diagrams illustrating a hand structure of a metal insulator semiconductor (MIS) device.

As shown in FIG. 1, the simulation apparatus 10 according to the present embodiment includes a process control unit 11, an input unit 12 that receives commands or data input from an operator, an output unit 15 that outputs a simulation result, a storage unit 13 that stores measured data or atomic structure data as input data, and a program storage unit 14 that stores a simulation program and the like.

The process control unit 11 includes an atomic structure creating unit 21, an electronic structure calculating unit 22, a first IV characteristic calculating unit 23 that calculates a current-voltage characteristic (i.e., an IV characteristic) of a device by a quantum theoretic method, such as a first principle calculation or the like, a correcting unit 24 that corrects an IV characteristic, a second IV characteristic calculating unit 25 that obtains an IV characteristic of the device by using a classical theory, such as a semiclassical approximation method, and a combining unit 26 that combines a first IV characteristic obtained by the first IV characteristic calculating unit 23 and a second IV characteristic obtained by the second IV characteristic calculating unit 25.

The atomic structure creating unit 21 creates an atomic structure so as to obtain IV characteristics of the device. A specific creating method is not particularly limited, and is appropriately selected by the device construction or size, or a calculation method of the electronic structure calculating unit 22 or the IV characteristic calculating units 23 and 25 of the rear stage. For example, it is possible to construct an atomic structure model by using a model structure that is created with the assumption of symmetry, or a molecular simulation, such as a molecular dynamics method or a Monte Carlo method. As the molecular simulations, a first principle method (e.g., a Car-Parrinello method) and an empirical potential method (e.g., a force-field potential method) are applicable.

In addition, the atomic structure creating unit 21 may read known basic atomic structures that are stored in the data storage unit 13 and apply the basic atomic structure to the device structure to thereby construct an atomic structure model. Further, the atomic structure creating unit 21 may read and use an atomic structure model that is created by another calculator.

The electronic structure calculating unit 22 performs a calculation of an electronic structure with respect to the atomic structure model, which is constructed by the atomic structure creating unit 21, by using a semiempirical method or a first principle method. The semiempirical method includes a tight-binding approximation method, and the first principle method includes a molecular orbital method (e.g., a Hertree-Fock method) and a density functional method.

The first IV characteristic calculating unit 23 calculates an IV characteristic of the device by using the electronic structure (e.g., a 1-electron effective Hamiltonian matrix) that is obtained by the electronic structure calculating unit 22. The first IV characteristic calculating unit 23 performs an IV characteristic calculation on the basis of a linear response theory. For example, by using the 1-electron effective Hamiltonian matrix on the localized base, a transmission coefficient of the device is obtained according to a matrix-Non-equilibrium Green's function (matrix-NEGF) method, and the IV characteristic is calculated on the basis of a Landauer-Buttiker equation.

The correcting unit 24 performs correction processing such that the IV characteristic (a theoretical prediction value) obtained by the first IV characteristic calculating unit 23 matches with a measurement value by a simple process. In principle, the theoretical prediction value and the measurement value need to quantitatively match with each other. However, the values do not match with each other in a nano-size system (for example, see non-patent document 1). Therefore, the present inventors have examined why the theoretical prediction value and the measurement value do not match with each other, and found out that discordance between the two values results from difficulty in strictly defining film thickness in the nano-size region and a band offset. Therefore, the inventors make it possible that the theoretical prediction value and the measurement value match with each other by a simple correction processing in the correcting unit 24.

First, as regards the film thickness, such as an insulating film constituting the device, in theory, it is possible to rigorously determine the interface structure, but there exists measurement accuracy to the measurement value, which depends on the technical limit. In addition, even though exact interface structure is obtained, the interface may be steep and the boundary may be ambiguous due to irregularities thereof. Therefore, an unambiguous definition is difficult. In general, an average value is used. However, deviation from the average value is relatively high in the nano-size device. Further, in the nano-size device, the deviation that results from the difference in the measuring methods is relatively high.

Therefore, when the interface structure is determined at the nano-size, prediction accuracy that is required for simulation needs to be calculated in advance, taking into consideration of measuring limits at the newest technology level and how electrical characteristic depends on the interface structure.

For example, on the assumption that a device has a Si/SiO₂/Si laminated structure, thickness of a SiO₂ film that is considerably thin (e.g., 10 nm or less) deviates from a predicted calculation value obtained from an electric measurement by a maximum of ±0.5 nm according to a different measuring method. In this case, it is known that when the film thickness deceases by 1 nm, a current across the device increases by about 10 times. Therefore, deviation of the film thickness that results from the measuring method has a great deal of influence on prediction accuracy of the IV characteristics.

Therefore, the present inventors have examined a plurality of film thickness measuring methods. In an ellipsometry method among the various measuring methods, the film thickness deviates from the predicted value obtained from electric measurement by ±0.1 nm. Therefore, the present inventors make accuracy and a film thickness measuring value according to the ellipsometry method correspond with the theoretical prediction value.

In terms of the Si/SiO₂ interface structure, there are two known views; one view that the interface is steep and the other view that the interface is ambiguous as oxygen diffuses. As the present inventors have performed verification of the interface structure according to high-accuracy simulation, they have obtained a result that a steep interface that has low coordination defect and slight irregularities is stable. Therefore, in the embodiment of the invention, a model that has a steep interface with respect to a device atomic structure is created and used for simulation.

In a dissimilar interface (e.g., Si/SiO₂), a position at which atomic species are changed was defined as an interface position at the atomic level. However, in the Si/SiO₂ interface, it is known that the interface position defined by the atomic species deviates from a position, at which a bandgap is changed, by about 0.5 nm. Specifically, it can also be known that as partial density of state in an oxygen 2 p orbital in a plane perpendicular to the SiO₂ film is viewed, the bandgap is changed at a position where an oxidization valence of Si in the SiO₂ film is not more than 3, that is, a position of an SiO₄ tetrahedron (i.e., a partially oxidized tetrahedron) that has at least one Si—Si binding.

In addition, it is thought that since permittivity changes according to a change of the bandgap, a change position of the bandgap corresponds to the interface position obtained by optical measurement, such as the ellipsometry method. Therefore, in the embodiment of the invention, theoretical definition of the interface position is made as a central position of a SiO binding that is formed right on the partially oxidized tetrahedron (i.e., on the SiO₂ film). When the model having the steep interface structure is used, the irregularities of the interface can be regulated to be not more than measurement accuracy (i.e., ±0.1 nm) by the ellipsometry method. In the embodiment of the invention, by using this definition, an error bar of the theoretical prediction value and the measurement value can be estimated on the basis of the indefiniteness of the interface position. Therefore, high accuracy prediction is possible.

FIG. 3A is a schematic diagram illustrating an atomic structure of a Si/SiO₂ interface, and FIG. 3B is a graph showing energy at positions of oxygen atoms of (1) to (5) of FIG. 3A. As shown in FIG. 3B, the minimum energy value at each of the positions of the partially oxidized tetrahedron, which is included in a SiOₓ film between a Si film and a SiO₂ film, gradually increases from the Si film toward the SiO₂ film. Further, energy at a position (1) matches with energy of a conduction band of Si, while energy at a position (5) matches with energy of a conduction band of SiO₂. In the embodiment of the invention, on the basis of the change of the minimum energy values, a central position L1 of a Si—O binding on a SiO₄ tetrahedron (i.e., a partially oxidized tetrahedron having Si based on reference numeral X and Y as a center), which includes at least one Si—Si binding, is set as a theoretical position of the Si/SiO₂ interface.

Next, a correction processing of a band offset will be described. FIG. 4A is a schematic view illustrating a band structure of an MIS device. In FIGS. 4A and 4B, C.B. denotes a conduction band of a semiconductor film S, V.B. denotes a valence band, and Ef denotes Fermi energy. Hereinafter, a description will be made on the assumption that an MIS device has a laminated structure of metal electrode M/insulating film I/semiconductor electrode S, which is shown in FIG. 4A.

When a voltage is applied to materials other than metal, an internal electrical potential gradient occurs. That is, when an externally applied voltage is V and a voltage, which is applied between electrode/device/electrode, is V′, if electrodes are made of metal, a relationship V=V′ is established. However, if one electrode is a semiconductor, a relationship V≠V′ is established around the device (the insulating film). In the MIS device, as it gets far from the insulating film, V and V′ become approximate to each other. However, since an area until the relationship V=V′ is established is extended on the order of 100 nm in a case of a silicon substrate, calculation of the area at the atomic level is unfeasible due to a large amount of calculation. Therefore, V′ needs to be estimated by a certain method so as to improve accuracy of calculation, which is known as a problem of the band offset.

However, in case that electron affinity of the semiconductor (e.g., a P-type semiconductor) is less than Fermi energy of the metal, when the externally applied voltage V is approximate to 0 (zero), charge transfer occurs at the MIS interface. Therefore, as shown in FIG. 4B, a band of the semiconductor film is bent. Thereby, a sub-band in a two-dimensional electron system is formed in the interface. Electron correlation of the two-dimensional electron system is large, and it may be impossible to accurately receive the electron correlation in the first principle calculation based on the Density Functional Theory (DFT) method, which lowers prediction accuracy of calculation. In addition, when an electric field is applied, an electron state changes. Therefore, an electronic structure needs to be obtained again using the self-consistency each time, and correspondingly, electrical current transmission of the device needs to be obtained again. However, this calculation is not realistic because calculation costs are drastically increased because of bad convergence.

Therefore, in the embodiment of the invention, the IV characteristic is calculated by the Landauer equation by using the electronic structure in the ground state and a transmission coefficient when V=0 is established (hereinafter, referred to as a calculation scheme 1). Even though a specific description will be made below, when IV characteristics of a corresponding theoretical prediction value (i.e., a calculation result of the scheme 1) and the measurement value are compared according to the definition of the film thickness, it is determined that both values have approximate shapes and almost match with each other by only voltage shifts.

In a physical point of view, the calculation scheme 1 is performed when the band is flat before the electron transfer occurs. Here, the band needs to be bent in a case of V=0 as shown in FIG. 4B. That is, the calculation of the scheme 1 corresponds to the TV characteristic when a flat band voltage V_{fb} is applied. In this case, since an effect of the electron correlation is small, calculation accuracy is secured. In addition, since the shift so as to correspond to the measurement value conforms to applying not V_{fb} in an original meaning but an exact V′ that is a result of including the band offset (here, this shift amount is referred to as V′_{fb}), the large-scale calculation does not need to be performed. Further, when the effect of the voltage shift is verified with respect to a plurality of different film thickness, it is found that V′_{fb} shows the same value for every film thickness. It makes sense that V_{fb} depends on only materials at such an ideal interface.

As described, in the correcting unit 24, the correction processing based on the flat band voltage V_{fb} of the device is performed on the result obtained by calculation using the calculation scheme 1 in the first IV characteristic calculating nit 23. As a result, it is possible to match the theoretical prediction value with the measurement value without performing the large-scale calculation. Therefore, it is possible to obtain an accurate calculation result, regulating calculation costs.

In addition, as an ideal interface is experimentally created and measured, and similarly, the ideal interface is theoretically created and predicted, V′_{fb} of material itself can be obtained. Therefore, the value V′_{fb} can be used for comparison when an irregular interface or an interface having a defect or impurity is calculated. That is, a change of V_{fb}, and ΔV_{fb} that is important for the process design can be predicted, and an influence of the irregularities or defect and impurity of the interface can be predicted.

The second IV characteristic calculating unit 25 calculates the IV characteristic of the device by using the semiclassical approximation method on the basis of the electronic structure of the device that is calculated by the electronic structure calculating unit 22. A quantum effect and an influence of the atomic structure on the IV characteristic are remarkably seen when the size of a system is small and when electric field intensity (E)(=V/tₒₓ wherein tₒₓ is film thickness of device (i.e., thickness of insulating film) is low. It is known that the IV characteristic obtained by using the semiclassical approximation method matches with the measurement value in other regions. Since the electronic structure is a function of the electric field intensity (E), when the IV characteristic is calculated by the first principle, the electronic structure needs to be calculated with respect to every electric field intensity E, thereby causing a large amount of calculation. In addition, when the size of the system is large, it is the same as described above.

Meanwhile, when the semiclassical approximation method is used, since the IV characteristic corresponds to an analytical equation, a calculation amount is not changed. Therefore, the simulation apparatus according to the embodiment of the invention has installed therein the second IV characteristic calculating method 25 that calculates the IV characteristic of the device according to the semiclassical approximation method in addition to the first IV characteristic calculating unit 23 that accurately calculates the IV characteristic by the first principle, such that the calculation costs in the first principle calculation can be reduced and accurate IV characteristic calculation can be performed.

The combining unit 26 combines the first IV characteristic obtained by the first IV characteristic calculating unit 23 with the second IV characteristic obtained by the second IV characteristic calculating unit 25. Further, the combining unit 26 derives an accurate IV characteristic of the device in a predetermined voltage range. As described above, under the high electric field intensity (E) and the large size of the system, the IV characteristic that is calculated by the semiclassical approximation method corresponds to the measurement value. Therefore, in the embodiment of the invention, the first IV characteristic is derived from calculation by the first principle in only the region where the quantum effect and the atomic structure are problems (i.e., the low electric field intensity (E) and the small-sized system). Further, in a case of the large electric field intensity E and the large-sized system, the second IV characteristic that is calculated by using the semiclassical approximation method is used.

Further, the combining unit 26 performs a process of combining the two IV characteristics. Specifically, IV characteristics by the first principle calculation of a plurality of small systems are obtained on condition of electric field intensity (E)=0, and IV characteristics are obtained by a semiclassical approximation method that corresponds to the sizes of the systems. Thereafter, a function that smoothly connects the two IV characteristics at a position where they cross each other or are adjacent to each other is derived. A parameter that characterizes this function is obtained as a function of the size of the system and the electric field intensity (E). The obtained function may be stored in the program storage unit 14 or stored as a table in the data storage unit 13. In the combining unit 26, this stored function or table is read, and the first and second IV characteristics, which are obtained by the IV characteristic calculating units 23 and 24, are received and processed, such that an IV characteristic for the device to be targeted can be obtained by combining the first IV characteristic and the second IV characteristic.

Simulation Method

According to the basic order of a simulation method according to an embodiment shown in FIG. 2, first, on the basis of input information from the input unit 12 shown in FIG. 1, an atomic structure model of a device (e.g., an MIS device), which is targeted as a simulation object, is created by the atomic structure creating unit 21 (step S1). The simulation method according to the present embodiment is not limited to the MIS device, but the method can be used for prediction of IV characteristics of various kinds of devices. In particular, the simulation method can appropriately be used for prediction of characteristics of molecular devices, organic devices, and electron spin devices, in which prediction of electric characteristics in the nano-size region is emphasized.

After the atomic structure model is created, an electronic structure calculation is performed by the electronic structure calculating unit 22 on the basis of the atomic structure model (step S2). The electronic structure calculating unit 22 reads necessary data and programs from the data storage unit 13 and the program storage unit 14. Further, the electronic structure calculating unit 22 executes the calculation program with respect to the atomic structure model that is supplied from the atomic structure creating unit 21.

Subsequently, the first IV characteristic calculating unit 23 performs an IV characteristic calculation of the device by a quantum theoretic method, which reflects the quantum effect and the atomic structure, on the basis of the electronic structure (step S3). The IV characteristic calculating unit 23 reads necessary data and programs from the data storage unit 13 and the program storage unit 14. Further, the IV characteristic calculating unit 23 performs IV characteristic calculation based on the atomic structure and the electronic structure that are supplied from the atomic structure creating unit 21 and the electronic structure calculating unit 22, respectively.

Next, the correcting unit 24 performs internal electric field correction according to measurement values on the basis of the first IV characteristic that is obtained by the first IV characteristic calculating unit 23 (step S4). A correction value (ΔV_{fb}) that is previously calculated based on the measurement values of the device is read from the data storage unit 13 and used for the internal electrical field correction. By the internal electrical field correction, the IV characteristic that is calculated in the ground state (v=0) can preferably match with the measurement value, and accurate IV characteristics can be obtained, regulating calculation costs.

The second IV characteristic calculating unit 25 performs IV characteristic calculation with respect to the device by using the semiclassical approximation method (step S5). According to strict IV characteristic calculation by the quantum theoretic method, it is possible to accurately predict IV characteristics with consideration of the atomic structure and the quantum effect, while a calculation amount becomes huge and the IV characteristic significantly deviates from the measurement value when the size of the system is large or electric field intensity (E) is high. Therefore, in the embodiment of the invention, prediction of IV characteristics by the semiclassical approximation method is performed on high electric field intensity (E) or a large size of system such that the IV characteristic preferably matches with the measurement value. As a result, it is possible to remarkably reduce the calculation costs and obtain appropriate theoretical prediction values. In the present embodiment, such IV characteristic calculation is performed after processing the correction of the first IV characteristic. However, the second IV characteristic calculation may be performed at the same time as the first IV characteristic calculation or the correction processing thereof.

After the first IV characteristic and the second IV characteristic are obtained, the combining unit 26 performs combination of the two IV characteristics (step S6). During the combination processing, in a case of a region of low electric field intensity (E) or a region of small-sized system, the first IV characteristic using the first principle calculation is applied, and in a case of a region of high electric field intensity (E) or a region of large-sized system, the second IV characteristic using the semiclassical approximation method is applied, such that combination of IV characteristic curves is performed. In the combining unit 26, the functions or tables (e.g. lookup tables) that are previously calculated based on the measurement values are read from the program storage unit 14 or the data storage unit 13, and are applied to the first IV characteristic and the second IV characteristic, thereby smoothly connecting the first and second IV characteristics to each other.

As a result, in the case of the region of the low electric field intensity (E) and the region of the small-sized system that are significantly affected by the quantum effect and the atomic structure, a theoretical prediction value that is strictly calculated by the quantum theoretic method can be obtained. Further, in the case of the region of the high electric field intensity (E) and the region of the large-sized system that are infeasible due to high calculation costs by the first principle calculation, a theoretical prediction value that preferably matches with a measurement value can be obtained by using the semiclassical approximation method with low calculation costs.

Therefore, according to the simulation method according to the embodiment of the invention, it is possible to regulate the calculation costs and accurately predict IV characteristics in a wide range.

Further, the simulation method according to the present embodiment of the invention has advantages as below over the related art simulation method.

As the related art simulation method, (A) a simulation method that performs parameter fitting of a simplified model and a measurement value, and (B) a simulation method that performs IV characteristic calcaulation by first principle calculation are known in general.

The (A) simulation method has a problem of low universality because it may be impossible to cope with a change in an atomic structure (Al). In addition, parameter fitting is required whenever a condition is modified, and a measurement value needs to be prepared for every condition (A2).

In the simulation method according to the embodiment of the invention, when an arbitrary atomic structure is given, an IV characteristic that reflects on the structure is calculated by the first principle, such that it is possible to correspond to all kinds of structures, and reliabilities of predicted values are high. Therefore, it is possible to solve the problem (A1).

Further, since it is based on the first principle calculation, parameter fitting is hardly required, and measurement values to be prepared can significantly be reduced as compared with the related art to thereby reduce development and design costs. As a result, it is also possible to solve the problem (A2)

The simulation method (B) has various kinds of problems as follows. It may be impossible to compare IV characteristics with measurement values because a definition of film thickness is ambiguous (B1). An electronic structure needs to be calculated again with respect to every externally applied voltage, which causes unrealistic calculation costs (B2). Development costs are huge in order to accurately obtain a bandgap or electron correlation (B3) A system needs to be increased in size so as to obtain an actual applied voltage to thereby cause unrealistic calculation costs (B4).

In the simulation method according to the embodiment of the invention, the IV characteristics preferably match with the measurement values by the above-described definition of film thickness to thereby solve the problem (B1). Further, as regards the problem (B2), it is possible to remarkably reduce the calculation costs because in the embodiment of the invention, the IV characteristic is calculated by using the electronic structure of the electrical field zero (V=0), and internal field correction is performed on the basis of the IV characteristic. As regards the problem (B3), since the bandgap is not necessarily accurate in the simulation method of the present embodiment, calculation is not required so as to obtain an accurate bandgap. As regards the problem (B4), since a correction value is derived and used based on the measurement value, the actual applied voltage does not need to be obtained. In addition, since it is possible to obtain correction values ΔV_{fb} with respect to other structures having different interface states, it is possible to easily cope with the change in the atomic structure.

Hereinafter, an IV characteristic simulation in a device having a Si/SiO₂/Si structure will be described in detail with reference to FIGS. 5 to 10.

First Process: Preparation for an Interface Atomic Structure Model

In the present embodiment, it is an object to predict IV characteristics of an oxide film on a Si substrate. In order to predict the IV characteristics of the device interposed between electrodes on the basis of an atomic structure, first, an atomic model that has electrodes and a device is set. That is, as shown in FIG. 5, a device 201 has a laminated structure formed of a Si film 211, a SiO₂ film 213, and a Si film 212 that include interfaces. Unit cells of crystals Si having a diamond structure are formed as electrodes 202 and 203, respectively, which have the device 201 interposed therebetween.

When an atomic structure model of the device 201 is created, in order that unit cell constants match at the surface of the single crystals Si (100) having a diamond structure, an atomic structure of crystalline at the interface is distorted and overlapped to thereby create a Si/SiO₂/Si interface structure. Since an influence of another interface other than the Si/SiO₂ interface is excluded, a three-dimensional periodic boundary condition needs to be satisfied.

In addition, bond length at the interface, ∠SiOSi, and ∠OSiC are hardly different from those in the crystalline, and Si is 4-coordinate and O is 2-coordinate. As a result, a steep interface model that has a stable structure but does not have an interface state is created. The model having the steep interface structure, which is used in the embodiment of the invention, does not have irregularities on the interface. Therefore, it is possible to minimize indefiniteness of the interface that results from the irregularities.

As described above, measurement accuracy of film thickness according to the ellipsometry method is about 0.1 nm, and indefiniteness of the interface of this degree remains. In theory, a bandgap changes around a Si—O binding that is right on a partially oxidized tetrahedron. When a position of the interface is theoretically defined as a central position of the biding, Si—O bond length is about 0.1 nm, which corresponds to an error bar of the measurement value. As a result, when the interface is theoretically defined within the accuracy limit where an ideal value and an actual value can be compared, it is possible to predict IV characteristics with high accuracy by theoretical calculation.

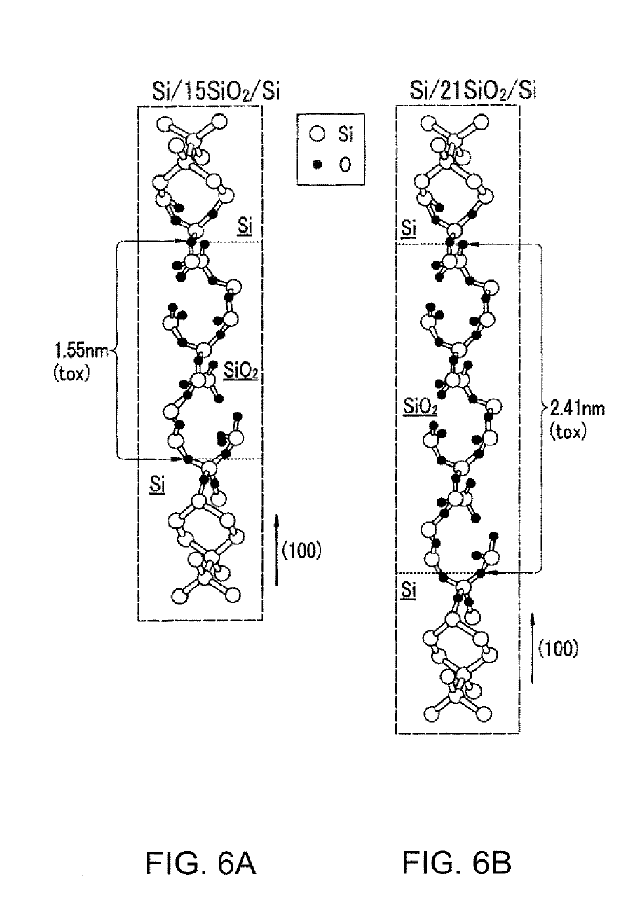

In the invention, two models are created; a model of Si/SiO₂/Si=8/15/8 numbers shown in FIG. 6A and a model of Si/SiO₂/Si=8/21/8 numbers shown in FIG. 6B. According to the above-described definition of Si/SiO₂ interface, the two models have film thickness tₒₓ of SiO₂ of 1.55 nm and 2.41 nm, respectively.

Second Process: Preparation for an Electronic Structure on the Basis of the Atomic Structure Model

Subsequently, by using the atomic structure of the first process, a first principle electronic structure calculation is performed, the structure is relaxed, and an electronic structure is obtained. Here, used is a calculation code that is capable of obtaining a ground state of an electron, which is two-dimensionally (in a horizontal direction to the film) and three-dimensionally periodic, by using pseudo potential and a Gaussian localized basis function on the basis of a density functional method. Gauss basis corresponds to a level at which polarization is included in Double-Zeta, and an exchange correlation-term by Perdew-Becke-Ernzerhof (PBE) is used. According to such setting, it is possible to obtain a calculation result with high accuracy.

In a case of the device, a unit cell of a slave structure (periodic in a horizontal direction to the film, and aperiodic in a vertical direction to the film) is used for calculation. As a result, it is possible to calculate the electronic device that accurately receives an influence of a two-dimensional system.

In a case of the electrodes, calculation is performed under a three-dimensional periodic boundary condition. Here, convergence is performed until an absolute value of a force that is applied to each of atoms becomes 0.1 eV/Å and a change of the total energy per convergence step is equal to or less than 0.1 eV. Under these conditions, calculation result having high reliability is obtained.

Third Process: First IV Characteristic Calculation Considering the Atomic Structure and a Quantum Effect

In the third process, a first IV characteristic is calculated by using the result that is obtained in the second process. The atomic positions and the electronic structures (i.e., a Hamiltonian matrix H, a convolution S, and an energy eigenvalue E) of the device 201 and the electrodes 202 and 203 are used as input values. The first IV characteristic of the device 201 is calculated by using a Landauer-Buttiker formula shown as below (equation 1).

$$I ( V ) = \frac{e}{π h} {\int }_{{μ}_{1}}^{{μ}_{2}} T ( E , V ) [ f ( E - {μ}_{1} ) - f ( E - {μ}_{2} ) ] ⅆ E \qquad Equation 1$$

In the equation 1, I is a current, V is a potential difference, T(E) and f(E) are a transmission coefficient T and a Fermi-Dirac distribution function f of the device at an energy E, respectively, e and h are an elementary electric charge and a Planck constant (bar means 1/2π), respectively. In addition, μ is a chemical potential in the electrode, and a difference between them corresponds to a value obtained by multiplying a voltage difference, which is applied to each of the electrodes 202 and 203, by e. That is, a relationship eV=μ₁-μ₂ is established.

The transmission coefficient T is obtained by the matrix-Non-equilibrium Green's function (matrix-NEGF) method. When a 1-electron effective Hamiltonian matrix H is divided into a device part Hm and electrode parts H1 and H2, it is possible to ignore an interaction between the electrodes. As a result, T(E) can be shown as a lower stage (Equation 2) by using a 1-particle Green's function G(E) of an upper stage of (Equation 2) that is defined from H.
G(E)=[(E+i0+)S−H
T(E)=Tr(Γ₁GₘΓ₂Gₘ⁺) Equation 2

Here, Gₘ is calculated as shown in an upper stage of Equation 3, and Γ denotes an interaction between the device and the electrodes and is defined as shown in a lower stage of Equation 3.

$$\begin{matrix}{G}_{m} = {( {E}_{m} {S}_{m} - {H}_{m} - {Σ}_{1} - {Σ}_{2} )}^{- 1} \\ {Γ}_{1 , 2} = i ( {Σ}_{1 , 2} - {Σ}_{1 , 2}^{+} )\end{matrix} \qquad Equation 3$$

In Equation 3, Eₘ and Sₘ are an energy eigenvalue and a convolution, respectively, of the device part. Σ is called a surface Green's function, and can be calculated from the electrode parts.

In general, T(E, V) needs to be calculated with respect to every applied voltage V. However, since the electronic structure needs to be correspondingly calculated again, a calculation amount is significantly increased. Therefore, the operation is difficult and unrealistic. Therefore, in the embodiment of the invention, the IV characteristics are calculated by fitting with T(E, V)=T(E, 0).

Fourth Process: Correction for a Flat Band Voltage by a Measurement Value

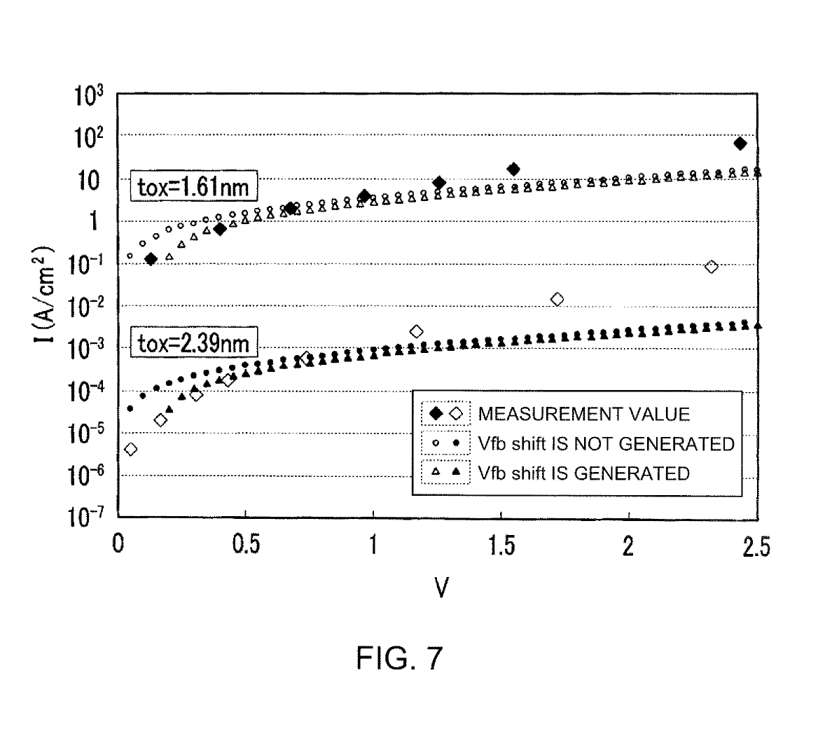

According to the first to third processes, IV characteristics of devices having tₒₓ=1.55 nm and 2.41 nm are obtained. Further, in order to facilitate comparison with measurement values, results of deriving IV characteristics at tₒₓ=1.61 nm and 2.39 nm by an interpolation processing that uses a method of the sixth process to be described below are shown in a graph in FIG. 7. In FIG. 7, results of the IV characteristics of the devices having tₒₓ=1.61 m and 2.39 nm that are obtained according to the first to third processes are plotted with circular marks. In the graph, the measurement values are plotted with diamond-shaped marks.

As shown in FIG. 7, when the predicted IV characteristics are compared with a corresponding theory and measured IV characteristics according to the above-described definition of film thickness, it can be known that they have similar shapes. Further, when an offset of the voltage is shifted according to orders to be shown below, it can be known that both parties match with each other. In addition, a method of estimating the offset with appropriate accuracy is devised.

What is plotted with triangular marks at each of the plots of tₒₓ=1.61 nm and 2.39 nm is subjected to the correction of the flat band voltage according to the following order. As clearly shown in FIG. 7, by performing the voltage correction, theoretical prediction values and measurement values can match with each other in a region of V=1 (V) or less.

In a case of an applied voltage V=0, a band of the interface will be being bent because an electric charge transfers due to a difference between work functions of the electrodes 202 and 203, and the device 201. Therefore, for measurement result, when the flat band voltage V_{fb} is applied, the applied voltage is V=0. Meanwhile, since a region where the band is bent is tens of nanometers in a direction of film thickness, a system of reconstructing V_{fb} is so large to be handled by the first principle calculation that it may be impossible to perform calculation.

In the present embodiment, since a small-sized model having ideal interfaces is used, it is assumed that V_{fb} is different from a measurement value. Meanwhile, an oxide film formed with high quality shows universal characteristics, which are almost the same, as viewed in various documents. Therefore, in the present embodiment, by making a measurement value disclosed in non-patent document 1 as a reference, the shape thereof is called I_{ref}(V). The IV characteristics obtained by the first to fourth processes are defined as I_{abinit}(V) and ΔV_{fb} is defined as x that satisfies Equation 4.

Here, Vₛ=1(V) is set in Equation 4. In the measurement value disclosed in non-patent document 1, V_{fb} is previously corrected by a certain method. Therefore, ΔV_{fb} defined in the present embodiment is used for convenience to match the theoretical prediction value and the measurement value with each other. Here, there is no physical meaning in the absolute value.

$$\begin{matrix}{G}_{m} = {( {E}_{m} {S}_{m} - {H}_{m} - Σ - Σ )}^{- 1} \\ {Γ}_{1 , 2} = ⅈ ( {Σ}_{1 , 2} - {Σ}_{1 , 2}^{+} )\end{matrix} \qquad Equation 4$$

In the present embodiment, ΔV_{fb}=−0.17 V is set. Further, a definition I_{modab}(V)=I_{abinit}(V−V_{fb}) is made. However, it is thought that by using a plurality of references, accuracy of V_{fb} is improved. In this case, the number of references is n_{ref}, and x that satisfies the following Equation 5 is V_{fb}.

$$min {\{ {\sum }_{nref} {\int }_{0}^{{V}_{sm}} ( ln [ {I}_{ref} ( V ) ] - ln [ {I}_{abinit} ( V - x ) ] ) )}^{2} ⅆ V \} \qquad Equation 5$$

Fifth Process: Combination with Semiclassical Approximation

Since the IV characteristics obtained by the first to third processes are served as T(E, V)=T(E, 0), accuracy decreases when it is distant from the vicinity of V=ΔV_{fb}. In addition, since ΔV_{fb} is small, deviation at V=0 is small. A region where V is large is a problem. Therefore, it is known by examination that it is possible to predict IV characteristics with appropriate accuracy by the semiclassical theory (WKB approximation) in the case of large V. In addition, when the present inventors compare two IV characteristics on the basis of plural tₒₓ, it can be known where a crossover of the two IV characteristics occurs. Therefore, the present inventors have devised a method of predicting IV characteristics with high accuracy, high throughput, and low costs by combining both parties.

Specifically, according to the first to fourth processes, I_{modab} (V) of several small systems is obtained. Then, an IV characteristic I_{wkb}(V) of the WEB approximation that corresponds to each film thickness is obtained by the following Equation 6.

$${I}_{WKB} ( V ) = \frac{4 π ln 2 e {m}_{Si}^{*} {k}_{B} T}{{h}^{3}} exp [ - \frac{8 π {t}_{ox} \sqrt{2 {m}_{Ox}^{*}}}{3 heV} \{ {ϕ}_{B}^{\frac{3}{2}} - {( {ϕ}_{B} - eV )}^{\frac{3}{2}} u ( {ϕ}_{B} - eV ) \} ] \qquad Equation 6$$

Here, u(x) is a step function (u=1 at x>0, and u=0 at x≦0) Further, m*ₛᵢ=0.35 m*ₒₓ=0.35 me (wherein me is a rest mass of an electron), and φ_{B}=3.34 eV are Si, an effective mass of an electron in the oxide film, and height of an energy barrier of the oxide film, which is measured from an end of a conduction band, respectively.

IV characteristics of an ultra-thin film are defined again as a function of an electric field Eₒₓ=V/tₒₓ. As regards several film thicknesses, the following Equation 7 is obtained.
I_{modab}(Eₒₓ,tₒₓ)=I_{modab}(V/tₒₓ)
I_{WKB}(Dₒₓ,tₒₓ)=I_{WKB}(V/tₒₓ) Equation 7

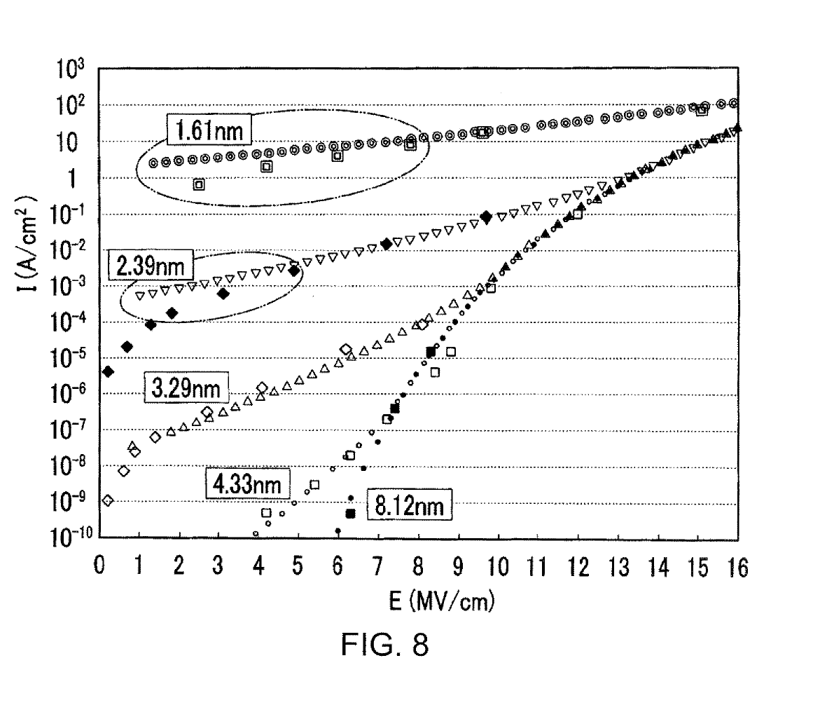

As shown in FIG. 8, when a tendency of IV characteristics is viewed at plural tₒₓ, I_{modab} is accurate at low Eₒₓ, and since a value is saturated at high Eₒₓ, I_{modab} deviates from actual measurement at high Eₒₓ. As shown in FIG. 8, I_{wkB} is overestimated at low Eₒₓ, and deviates from a measurement value, and I_{wkB} is accurate at high Eₒₓ. Therefore, it is thought that an appropriate predicted value is obtained when I_{modab} and I_{wkb} are replaced with each other by finding out a value Eₒₓ that shows the minimum difference from the measurement value.

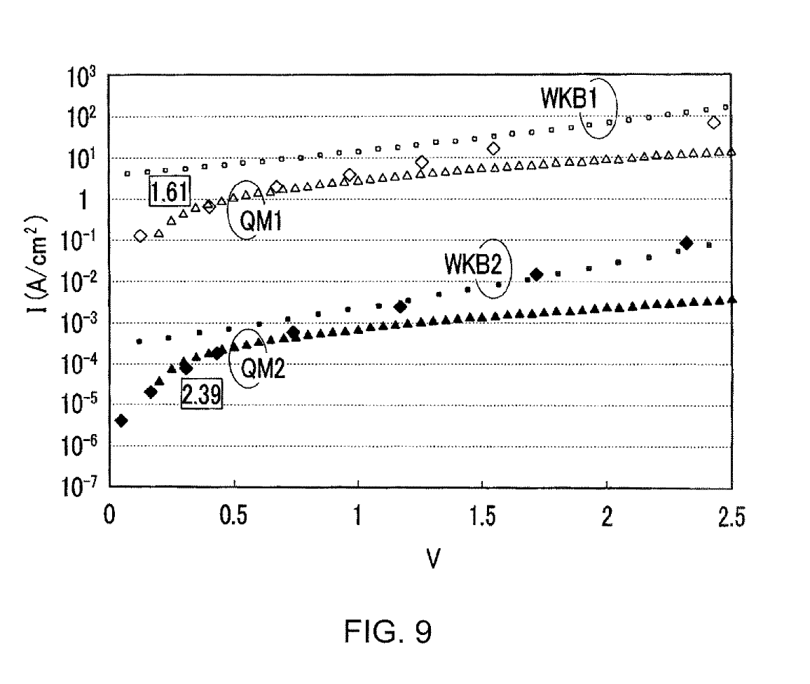

Here, FIG. 9 shows a first IV characteristics I_{modab} and a second IV characteristics I_{wkB} at tₒₓ=1.61 nm and 2.39 nm together with measurement values. In addition, like the first IV characteristic on the basis of the second IV characteristic obtained by the method, in order to facilitate comparison with measurement values, results of deriving IV characteristics at tₒₓ=1.61 nm and 2.39 nm by an interpolation processing that uses a method of the sixth process to be described below are shown in a graph in FIG. 9.

In FIG. 9, a curve attached with QM1 is a first IV characteristic at tₒₓ=1.61 nm, and a curve attached with QM2 is a first IV characteristic at tₒₓ=2.39 nm. In addition, a curve attached with WKB1 is a second IV characteristic at tₒₓ=1.61 nm, and a curve attached with WKB2 is a second IV characteristic at tₒₓ=2.39 nm.

As shown in FIG. 9, since the first IV characteristic and the second IV characteristic do not actually cross each other, if replacement is formally made at any point, the IV characteristics become discontinuous. Therefore, in the embodiment of the invention, a function f (Eₒₓ, tₒₓ) is defined so as to smoothly connect the first IV characteristic and the second IV characteristic, and corrected Iₗₑₐₖ is defined by the following Equation 8.
Iₗₑₐₖ(Eₒₓ, tₒₓ)=I_{modab}*f+I_{WKB}*(1−f) f(Eₒₓ,tₒₓ)={1+exp[(Eₒₓ−u)/b]}−1 Equation 8

Here, b is a range of a region that smoothly connects the curves of the first and second IV characteristics, and u is a central value thereof. With more detailed examination, it can be known that u and b are monotone functions of tₒₓ, and [symbol] can linearly be approximated (Equation 9)
u(tₒₓ)=u1tₒₓ+u0
b(tₒₓ)=b1tₒₓ+b0

Coefficients (u1, u0) and (b1 and b0) shown in Equation 9 can be determined by using a measurement value I_{meas by} using equations 1 to 4 shown in the following Equation 10.
min {(Iₘₑₐₛ(Eₒₓ,tₒₓ)−I_{modab}(Eₒₓ−x,tₒₓ))²} (1)
min {(Iₘₑₐₛ(Eₒₓ,tₒₓ)−I_{WKB}(Eₒₓ−x,tₒₓ))²} (2)
u(tₒₓ)={Eₘₑₐₛ(tₒₓ)+Eₘᵢₙ(tₒₓ)}/2 (3)
b(tₒₓ)={Eₘₐₓ(tₒₓ)−Eₘᵢₙ(tₒₓ)}/2 (4)

Specifically, first, x that satisfies an equation 1 of the Equation 10 is Eₘᵢₙ(tₒₓ) and x that satisfies an equation 2 is Eₘₐₓ(tₒₓ). Then, Eₘᵢₙ(tₒₓ) and Eₘₐₓ(tₒₓ) are obtained with respect to the two different tₒₓ, and (u1, u0) and (b1 and b0) are obtained by combining an equation 3 and an equation 4 of the Equation 10.

In the present embodiment, (u1, u0)=(−8.14, 23.62) and (b1 and b0)=(−4.65, 12.21) are obtained.

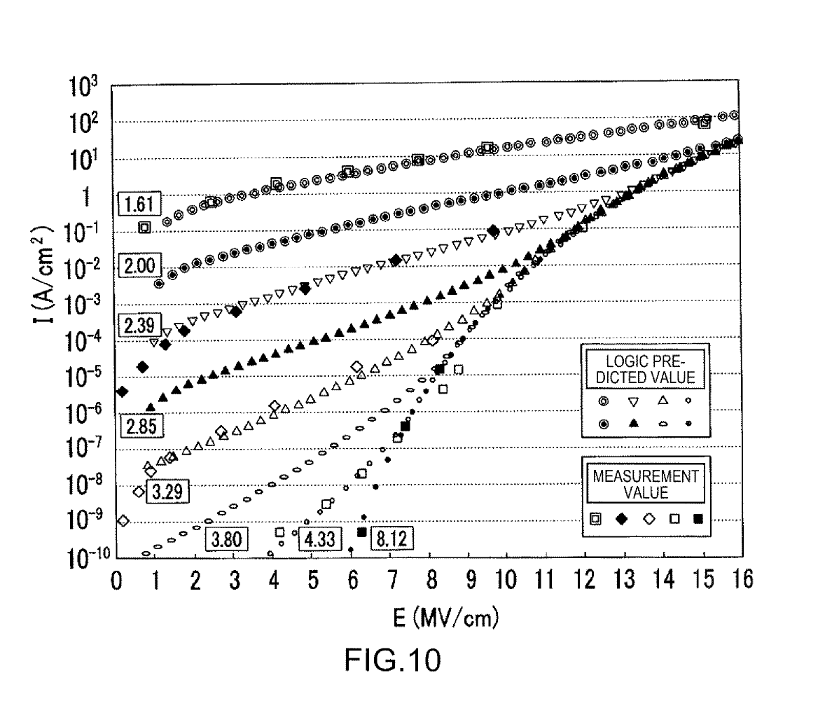

The result of obtaining the IV characteristics with respect to plural tₒₓ is shown in FIG. 10. As shown therein, figures surround by rectangular frames are values of tₒₓ of respective devices (film thickness).

As clearly shown in graphs of tₒₓ=1.61 nm, 2.39 nm, 3.29 nm, 4.33 nm, and 8.12 nm together with measurement values of FIG. 10, the theoretical prediction values of the IV characteristics that are obtained by the simulation method according to the embodiment of the invention preferably match with the measurement values of respective film thickness. Therefore, it is possible to accurately predict IV characteristics without spending the calculation costs.

Sixth Process: Expansion Toward Arbitrary Film Thickness

In terms of a size of an arbitrary system (i.e., film thickness), it is possible to predict IV characteristics by numerical interpolation and extrapolation by using the several IV characteristics obtained by the first to fifth processes. Since a dynamic range of the IV characteristics is 10 places or more, I is expressed by a logarithm in general. However, when linear interpolation and extrapolation being used in general are used, a deviation of the shape increases. Therefore, preferably, after the logarithm is taken, the linear extrapolation is performed, and it returns to an original state later, thereby improving accuracy.

Further, as described above, in the present embodiment, after the interpolation of the sixth process is performed on the basis of the first IV characteristics obtained by the first to third processes, correction processing of the fourth process is performed. In the simulation method of the embodiment of the invention, the fourth process may be performed before or after the sixth process. In addition, since the correction processing of the fourth process is performed on the first IV characteristics after the interpolation processing is performed, the second IV characteristics to be combined with the first IV characteristics in the fifth process are subjected to the interpolation processing of the sixth process before the combination processing.

Specifically, when as several Iₗₑₐₖ(Eₒₓ, tₒₓ)are obtained, Lagrange interpolation is performed by setting X=tₒₓ and X=In[Iₗₑₐₖ]in respective equations shown in Equation 11. A current Iᵢₙₜ(tₒₓ) of the arbitrary film thickness tₒₓ is obtained by Iᵢₙₜ(tₒₓ)=exp[F(x)].

In FIG. 10, IV characteristics at tₒₓ=2.00 nm, 2.85 nm, and 3.80 nm that are obtained by the interpolation are also shown. As clearly shown in graphs, it is possible to reasonably predict IV characteristics by using the interpolation processing method of the sixth process.

$$\begin{matrix}P ( x ) = {\prod }_{i} ( x - {x}_{i} ) \\ {d}_{i} = {\prod }_{j \neq i} ( {x}_{i} - {x}_{j} ) \\ F ( x ) = P ( x ) {\sum }_{i} \frac{1}{x - {x}_{i}} \frac{{f}_{i}}{{d}_{i}}\end{matrix} \qquad Equation 11$$

Manufacture of Thin Film Transistor

Next, a process of manufacturing a thin film transistor designed by determining a device characteristic or a process on the basis of the aforementioned IV characteristic simulation method will be described.

In here, the thickness of a silicon oxide film on a silicon substrate of the thin film transistor and a film forming method (process) are determined on the basis of the TV characteristic simulation method.

At first, using the IV characteristic simulation method according to the embodiment of the invention, a method of determining the thickness of a silicon oxide film on a silicon substrate of the thin film transistor and the film forming method (process) will be described.

Firstly, a plurality of atomic structure models having different defects are created (step S21). IV characteristics of the plurality of atomic structure models are calculated by using the IV characteristic simulation method (step S22). Next, the IV characteristic is expanded to an arbitrary thickness (step S23). When the IV characteristic is obtained from the arbitrary thickness, logic value thereof is compared with a measurement value previously obtained from an experiment. In the experiment, the silicon oxide film is formed by a plurality of processes, and an IV characteristic thereof is measured. The atomic structure of the silicon oxide film in the respective processes, which are used for the experiment, is estimated on the basis of the result of the comparison (step S24). The thickness or the process of the silicon oxide film having the estimated atomic structure in the respective processes are determined by referencing the simulation result obtained at step S23 so as to have a desired characteristic (step S25).

Next, on the basis of the determined thickness and the process, a method of manufacturing a thin film transistor will be described. In this embodiment, a case when a silicon thin film is formed on an insulating film such as a glass film, as a semiconductor film for manufacturing a transistor will be exemplified.

First, on the insulating substrate 1, a silane based reactive gas is used as a supply source of the silicon atom. For example, an amorphous silicon film 2 is formed by using a low pressure chemical vapor deposition method (LPCVD) that uses a disilane (Si₂H₆) gas or a plasma enhanced chemical vapor deposition method (PECVD) that uses a monosilane (Si₂H₄) gas.

Next, an energy required to crystallize an amorphous silicon atom is supplied from outside to the formed amorphous silicon film 2 to recrystallize the amorphous silicon atom. As a result, a polycrystalline silicon film 2 is formed. Crystalline properties such as a grain size of the polycrystal or orientation of a crystal are previously set by using the device simulation so as to obtain necessary properties such as carrier mobility. As for the recrystallzing method, the most suitable method and a condition for obtaining the above crystalline property are selected. For example, a laser crystallizing method that irradiates light using an excimer laser or a method of performing a thermal treatment in a heating furnace to be grown in a solid phase can be selected.

The obtained polycrystalline silicon film 2 is desirably patterned by using a photolithographic method, and then a dielectric film 3 which will be used as a gate oxide film is formed. The dielectric film 3 is a silicon oxide film (SiOₓ), and is deposited on the entire surface of the substrate. The dielectric film 3 is formed by using a thermal CVD method that is determined as the most suitable method on the basis of the above-described simulation method so as to have a thickness that is determined as the suitable thickness on the basis of the above-described simulation method.

Next, impurities are doped into the semiconductor film so as to adjust a threshold value by performing ion implantation, which is capable of easily and accurately controlling the doping level. The kinds of elements to be doped are determined by the design of the thin film transistor. However, in this embodiment, since an n-type thin film transistor is described, boron (B) of a third (III) group impurity that serves as an acceptor in the silicon crystal is implanted.

After the doping process is performed on the semiconductor film, a thin film forming process is performed to form a gate electrode 4. A thin film formed of a metal or polysilicon selected as a material for the gate electrode is deposited on the entire surface of the substrate by using a CVD method or a sputtering method, and then patterned by a photolithographic method to have a predetermined gate electrode shape.

Phosphorus (P) is implanted to make a source region 5 and a drain region 6 have a conductive type of n+. In this process, by using the gate electrode 4 that was patterned as a mask, Phosphorus (P) is implanted so as to be self aligned. In detail, phosphorus is not implanted into a region of the polycrystalline silicon film directly below the gate electrode, but the region maintains a state that the boron ion is implanted.

After implanting boron into the region of the semiconductor film, and phosphorus into the source region 5 and the drain region 6, a process of recovering a crystal lattice state, which is in disarray by the ion implantation, and electrically activating boron and phosphorus as dopants is performed.

As a method of activating the dopant, various methods are known. For example, when selecting an activation method of maintaining a substrate at high temperature for a long time, the dopant activation can be performed with a simple device, which is an advantage in that a thin film transistor can be manufactured at a low cost. However, the dopant activating method is not limited to the above-mentioned method, and a laser activating method can be used. Further, when the dopants are activated by using the laser activating method, the same laser light source as the laser used in the crystallizing process of the amorphous silicon thin film shown in FIG. 6A can be used, or a laser light source having different wavelengths can be used.

After the dopant activating process, an interfilm insulating film 7 is formed so as to electrically insulate the transistors on the substrate from each other, then the dielectric film 3 and the interfilm insulating film 7 formed on the source region 5 and the drain region 6 are removed by using a photolithographic method to form a contact hole, and then thin films for the source electrode 8 and the drain electrode 9 are deposited, and finally, the films are patterned as the source electrode 8 and the drain electrode 9. Therefore, the polycrystalline thin film transistor is completed.

In this embodiment, a P type semiconductor film is used, and boron is selected as a dopant to be implanted. Further, a gate voltage-drain current characteristic is shifted to a plus voltage side. For example, another acceptor impurity such as aluminum (Al) may be selected as a dopant. An n-type semiconductor film may also be used in respect to the design of a transistor. In that case, a donor impurity such as phosphorus (P) may be selected as a dopant.

In the above embodiment, even though an ion implantation method that accompanies mass analysis of a dopant as a method of doping a semiconductor film is selected as an example, the doping method is not limited thereto. That is, another doping method that does not accompany mass analysis of a dopant may be used. Specifically, when using the doping method that does not accompany mass analysis, it is possible to reduce structural defects such as displacement or electrical defects such as a fixed charge occurring in a semiconductor film, a gate insulating film, a substrate insulating film or an interface therebetween due to ion doping. In contrast, when using the doping method that accompanies mass analysis, it is possible to restrict structural defects such as displacement or electrical defects such as a fixed charge occurring in a semiconductor film, a gate insulating film, a substrate insulating film or an interface therebetween due to impact of superfluous ions. Accordingly, a method applicable to obtaining a desired characteristic of a thin film transistor may be appropriately selected

The doping of the semiconductor film is not necessarily performed after the process of polycrystallizing the amorphous silicon film, but may be simultaneously performed with the process of forming the amorphous silicon film. For example, when performing the doping using an ion implantation method, the amorphous silicon film is formed using gas containing a silicon element serving as a base material of the transistor and gas containing a dopant element at the same time to obtain an amorphous silicon film containing an impurity that will serve as a dopant.

A process of doping the channel region, the source region and the drain region with impurities may be performed regardless of the order of manufacturing processes as long as the doping process is performed on the above films. Doping is not necessarily performed on the channel region

Further, in this embodiment, even though the simulation method according to the embodiment of this invention is applied to a polycrystalline silicon thin film transistor that forms the semiconductor film using polycrystalline silicon, this simulation method may be applied to a polycrystalline semiconductor device that forms a semiconductor film using polycrystal such as GaAs. Furthermore, the simulation method according to the embodiment of this invention may be applied to a process of forming a bulk MOS transistor that is formed on a monocrystalline silicon wafer or an MIS transistor.

Further, even though the simulation method according to the embodiment of this invention is used to determine a film thickness and a process, the simulation method is applicable to various objects.

### Other Embodiment

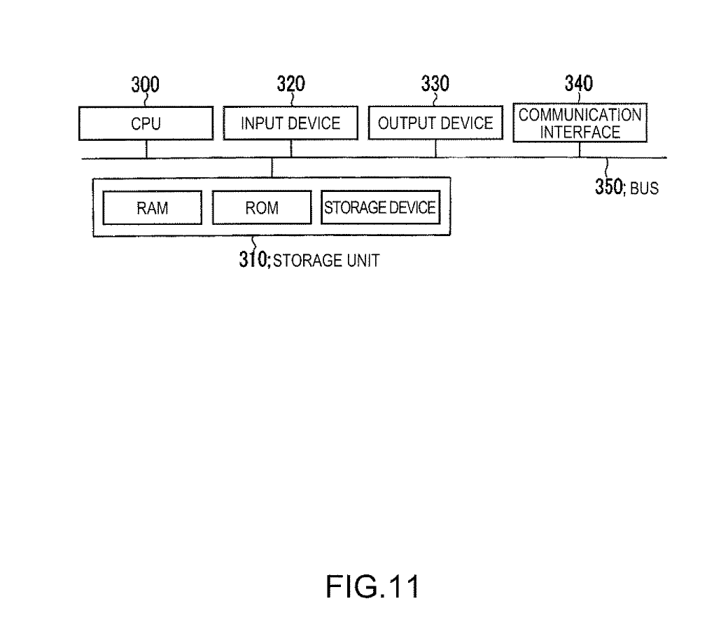

FIG. 11 is a schematic block diagram showing a configuration of the simulation apparatus 10 shown in FIG. 1 according to another embodiment. Referring to FIG. 11, the simulation apparatus 10 includes a CPU (central processing unit) 300, a storage device 310 configured by a storage unit such as a RAM (random access memory), a ROM (read only memory), a hard disk, etc., an input device 320 such as a keyboard or a mouse, an output device 330 such as a liquid crystal display device, and a communication interface 340 that communicates with various devices through a network, which are connected to each other through a bus 350.

In this case, a program (for example, application software) that implements functions of the process control unit 11, the output unit 15, and the input unit 12 shown in FIG. 1 is stored in the storage unit 210, and read by the CPU 200 to implement the respective functions.

Further, the program (for example, application software) that implements functions of the process controlling unit 11, the output unit 15, and the input unit 12 shown in FIG. 1 is recorded in a computer readable recording medium, and the program recorded in the recording medium is read by a computer system to perform the functions so that the product management is performed. The ‘computer system’ includes a hard ware such as OS or peripheral devices.

The term ‘computer readable recording medium’ refers to a storage device including a portable medium such as a flexible disk, a magneto-optic disk, a ROM, a CD-ROM, etc. and a hard disk that is mounted in the computer system. Further, the ‘computer readable recording medium’ includes a means that dynamically stores a program for a short time, such as a communication line when transmitting a program through a network such as an internet or a communication line such as a phone line, or a means that stores a program for a limited time, such as a volatile memory in a computer system of a client or a server when transmitting a program. The above-mentioned program may be realized as a part of the above-described functions, or may be combined with all programs that are recorded in the computer system to perform the above-described functions.

The function of the process control unit 11, etc. of FIG. 1 may be implemented as a semiconductor integrated circuit (semiconductor device) such as IC or LSI.

The input device 320 includes a keyboard or a mouse, and the output device 330 includes a display device such as a liquid crystal device or a CRT. The storage device 310 corresponds to the data storage unit 13 and the program storage unit 14 shown in FIG. 1. The communication interface 340 is combined with the CPU 200 and implements the functions of the output unit 15 and the input unit 12 shown in FIG. 1.

As described above, even though the embodiments of this invention are described with reference to the drawings, the specific configuration is not limited to the embodiments and includes a design within a range without departing from the gist of this invention.

The entire disclosure of Japanese Patent Application Nos. 2005-258849, filed Sep. 7, 2005 and 2006-223022, filed Aug. 18, 2006 are expressly incorporated by reference herein.

What is claimed is:

1. An apparatus for simulating a current-voltage characteristic of a device comprising:
an atomic structure creating unit that creates an atomic structure model of the device;
an electronic structure calculating unit that calculates an electronic structure in the atomic structure model;
a first IV characteristic calculating unit that calculates the current-voltage characteristic of the device by considering a quantum effect and the atomic structure on the basis of the electronic structure calculated by the electronic structure calculating unit;
a second IV characteristic calculating unit that calculates the current-voltage characteristic on the basis of the electronic structure using a semiclassical approximation method; and
a combining unit that combines a first current-voltage characteristic obtained by the first IV characteristic calculating unit and a second current-voltage characteristic obtained by the second IV characteristic calculating unit such that the first current-voltage characteristic is applied to a low voltage side on the basis of a position of approaching the both first and second current-voltage characteristics and the second current-voltage characteristic is applied to a high voltage side on the basis of approaching the both first and second current-voltage characteristics to obtain the current-voltage characteristic of the device.

2. The apparatus for simulating a current-voltage characteristic of a device according to claim 1, further comprising:
a correcting unit that corrects the first current-voltage characteristic obtained by the first IV characteristic calculating unit using a voltage correction value,
wherein the combining unit combines the first current-voltage characteristic corrected by the correcting unit and the second current-voltage characteristic.

3. The apparatus for simulating a current-voltage characteristic of a device according to claim 1,
wherein in the atomic structure creating unit, an atomic structure model of the device including a first material, a second material, and a third material having an interface of the first and second materials is created as an atomic structure model having a steep interface having no irregularities or coordination defects.

4. The apparatus for simulating a current-voltage characteristic of a device according to claim 3,
wherein in the atomic structure creating unit, an atomic structure model of the device including a SiO₂ film and a Si film which have an interface therebetween is created as an atomic structure model having the steep interface having no irregularities or coordination defects between the SiO₂ film and the Si film.

5. The apparatus for simulating a current-voltage characteristic of a device according to claim 4,
wherein the interface of the SiO₂ film and the Si film is set at a central position of a Si—O binding that is positioned at a SiO₂ film side of the SiOₓ tetrahedron where an oxidation valence of Si of the SiO₂ film is 3.

6. A simulation method, comprising:
creating an atomic structure model of a device;
calculating an electronic structure in the atomic structure model;
calculating a first current-voltage characteristic of the device by considering a quantum effect and the atomic structure on the basis of the calculated electronic structure;
calculating a second current-voltage characteristic using a semiclassical approximation method on the basis of the electronic structure; and
combining the first current-voltage characteristic and the second current-voltage characteristic such that the first current-voltage characteristic is applied to a low voltage side on the basis of a position of approaching the both first and second current-voltage characteristics and the second current-voltage characteristic is applied to a high voltage side on the basis of the position of approaching the both first and second current-voltage characteristics to obtain the current-voltage characteristic of the device.

7. The simulation method according to claim 6, further comprising:
correcting the first current-voltage characteristic obtained in the calculation of the first current-voltage characteristic using a voltage correction value,
wherein in the combining of the first current-voltage characteristic and the second current-voltage characteristic, the corrected first current-voltage characteristic and the second current-voltage characteristic are combined.

8. The simulation method according to claim 6,
wherein in the creating of the atomic structure model of the device, the device is set as a device including a first material, a second material, and a third material having an interface of the first and second materials, and interfaces among the first material, the second material, and the third material are set as steep interfaces having no irregularities or coordination defects.

9. The simulation method according to claim 8,
wherein in the creating of the atomic structure model of the device, an interface between a SiO₂ film and a Si film of the device including the SiO₂ film and the Si film which have the interface therebetween is set as a steep interface having no irregularities or coordination defects.

10. The simulation method according to claim 9,
wherein the interface of the SiO₂ film and the Si film is set at a central position of a Si—O binding that is positioned at a SiO₂ film side of the SiOₓ tetrahedron where an oxidation valence of Si of the SiO₂ film is 3.

11. A semiconductor device that is designed on the basis of a current-voltage characteristic obtained by the simulation method according to claim 1.
